(19) United States
(12) Patent Application Publication
(10) Pub. No.: US 2013/0106803 A1
(43) Pub. Date: May 2, 2013

(54) DATA STORAGE DEVICE WITH DATA INPUT FUNCTION

(71) Applicant: Joon Yong Wayne Tan, Singapore (SG)

(72) Inventor: Joon Yong Wayne Tan, Singapore (SG)

(73) Assignee: T-DATA SYSTEMS (S) PTE LTD, Singapore (SG)

(21) Appl. No.: 13/808,345

(22) PCT Filed: Jul. 6, 2010
(86) PCT No.: PCT/SG2010/000253

§ 371 Date: Jan. 4, 2013

(51) Int. Cl. G06F 3/03

(52) U.S. Cl. CPC G06F 3/03
USPC 345/179

(57) ABSTRACT

A data storage device 5 having a storage capacity of at least 8 Mbyte is surrounded by a housing including a stylus portion 23, having a tip 25 for indicating a position. The stylus includes a position sensing device for generating position data indicative of the position of stylus. The stylus further includes wireless communication means for transmitting and/or receiving data for storage, and also transmitting the position data. The position sensing device may be an accelerometer. Alternatively, it may be a laser-reading head 243, for generating a signal based on received reflections from an emitted laser beam 245. The data storage device may further include an audio sensor 142, 242, and be arranged to distinguish vocal commands in the output of the audio sensor 142, 242.

### FIELD OF THE INVENTION

The present invention relates to devices having the dual functions of storing user data and of enabling command input to a computer system.

### BACKGROUND OF INVENTION

Recently there has been great interest in providing data storage devices using which a user is able to transfer data between components of a computer system, or between computer systems.

For example, one of the present inventors has proposed in PCT application PCT/SG01/00136, published as WO 03/003141, entitled “Method and devices for data transfer” (the disclosure of which is incorporated herein by reference) a data storage device for use in a computer system including a computer device and one or more other external electronic devices. The external devices are of the type referred to as “slave devices”, and examples of such electronic devices include a camera, a video camera, an organiser, an MP3 player, or a PDA (personal assistant). The data storage device includes a wireless transceiver (transducer) for receiving data (which the data storage device stores), and for transmitting data stored within it. The computer device too, and each of the other electronic devices, includes a respective wireless transducer. Thus, the data storage device can be used for transferring data between the computer device and the various external devices. Since the storage device is substantially devoted to storage of data, it can accommodate a memory which is larger than in most other portable electronic items. Furthermore, since the data transfer is wireless, physical connectors (such as cables, sockets and plugs) are not required, so data can be transferred within the computer system despite the very large number of existing standards for physical connectors.

In a further patent application PCT/SG2004/000119 (“Data input device, systems using the device, and methods for operating such systems”, the disclosure of which is incorporated herein by reference) one of the present inventors has proposed that the above data storage device should be shaped as a stylus, and that it is used with a computer device having means for detection the position of the stylus. This permits the stylus, in addition to its data storage function as explained above, to be used as a data input device. The computer device may be a PDA having a touch sensitive surface, so that the user can stroke this surface with the tip of the stylus to input data. Alternatively, the position of the tip may be detected by a sonar or radar technique.

### SUMMARY OF THE INVENTION

The present invention aims to provide a new and useful data storage device.

In general terms, the invention proposes that a data storage device having data storage means and a wireless communication transceiver, and shaped in the form of a stylus, should include one or more position sensing devices. The output(s) of the position sensing device(s) permit motions of the stylus to be detected, so that the data input device can be used to input data to a computer device which does not have a mechanism for detecting the position of the stylus.

The data storage device uses the outputs of the position sensing device(s) to generate position data which is transmitted out of the device into a host. The term “position data” is used herein with a sense wide enough to include any data indicative of the position of any portion of the stylus. Thus, the term “position data” embraces both the outputs of the position sensing device(s), and/or data derived from those outputs, such as acceleration or velocity data. In other words, the data storage device may simply relay the output(s) of the position sensing device to the host, or alternatively perform any level of algorithms on the outputs of the position sensing device in order to generate the position data. For example, in a case in which a user is to indicate one of a number of choices by moving the data storage device to one of a number of respective positions or in one of a number of respective directions, the calculation of which choice the user has made may be performed within the host, or alternatively within the data storage device itself, and in the latter case data sent by the data storage device to the host and which indicates that choice, is to be regarded as position data.

In a preferred example, the position sensing device is a laser-reader head, that is a device which includes a laser generation unit which generates and transmits a laser beam out of the device, a light sensor unit which receives reflected light from the laser beam, and a signal generation unit which generates a signal based on the reflected light. The laser beam may be transmitted in a plurality of directions, e.g. within a certain angular range, so that the reflected light indicates the characteristics of a surface which the laser beam impacts. By comparing the reflected light at two different times, the position of the position sensing device (and in particular any change in the position of the device) can be determined. For example, it at a first instant the reflected light indicates a certain pattern on the reflected surface, and at a second instance the reflected light shows the same pattern by displaced by a certain distance in a certain direction, it can be inferred that the position sensing device has, between the two times, moved by that distance in the opposite direction. Similarly, if at the second instant the reflected light indicates that the pattern has been stretched or compressed in a certain direction, that indicates that the position sensing device has been rotated relative to the reflective surface about an axis transverse to that direction. More general motions of the position sensing device may be combinations of these possibilities.

Thus, in this case the “position data” may be a signal characterizing the reflected light (e.g. the intensity of reflected light received from each of a plurality of respective angles about the light sensor unit). Alternatively, it can be data characterizing the difference between the reflected light at two or more times (e.g. data showing a displacement and/or compression of the reflected light). Or, in a third possibility, the “position data” may be data directly indicating the change in position of the position sensing device which is implied by the change in the pattern of reflected light between the two times (e.g. data encoding one of more variables indicating respective displacements of the position sensing device and/or variables indicating respective rotations of the position sensing device). Or, in a fourth possibility, it may be data indicating a translational or rotational velocity of the position sensing device, or even a translational or rotational acceleration of the position sensing device. Or in a fifth possibility it may be data indicating which of a number of choices a user has made out of a set of choices defined by software running on the data storage device or the host. In other examples, the position sensing device(s) additionally or alternatively comprise device(s) which do not determine their position compared to a reference external to the data storage device, such as gyroscope(s) and/or accelerometer(s).

Embodiments of the invention may be used with a wider range of computer systems than a stylus which requires the position sensing to be done by external position sensing device (such as a touch sensitive screen). This is important because it is envisaged that the present data storage device will be transported between a number of different computer systems, thereby permitting data transfer between them, and so compatibility with many systems is advantageous.

Preferably the outputs of the position sensing devices (or the data derived from them) are transmitted out of the device using same the wireless transceiver which is used for data transfer to/from the data storage means.

This arrangement is particularly advantageous because it permits the wireless communication to carry both data for storage into and/or retrieved from the data storage,

Note that the position sensing device(s) are preferably integral with the rest of the data input device, e.g. within a housing of the data input device. They may for example be provided on a common PCB with the data storage means.

In certain embodiments of the invention the position data obtained from the position sensing device relates only to the position of the stylus tip, and not to the orientation of the device. Furthermore, the position data may just encode translational motions normal to the axis of the stylus.

Specifically, a first expression of the invention is a data storage device having:
a non-volatile memory;
a wireless transceiver for transmitting and receiving data;
a control processor for storing data received by the wireless transceiver in the memory, and for extracting data from the memory and transmitting it to the wireless transceiver for transmission;
a housing having an outer profile including a stylus portion defining a tip; and
one or more position sensing devices in fixed positional relationship to the housing.

Preferably, the data storage capacity of the non-volatile memory is at least 8 MB. Preferably it is a solid state memory (e.g. composed of one or more flash memory devices, such as NAND flash memory devices), but it may alternatively (or additionally) comprise a hard disk memory device and/or a storage device using an optical storage medium.

Preferably, the data storage device further contains an audio sensor. The data storage device may include a controller running software which is able to recognise commands input using the audio sensor. Or the data storage device may transmit the output of the audio sensor to the host, which runs software to recognise the commands. Thus, in one form, a user may be able to select from multiple options (defined by software running on the data storage device or on the host) either by moving the data storage device or by speaking a command.

Preferably, the data storage device further includes at least one biometric sensor for recording a biometric characteristic of a user, and a verification processor for comparing the biometric characteristic with a characteristic stored by the sensor, the verification processor controlling whether the data storage device performs at least one of its functions in dependence upon whether the recorded biometric characteristic matches the stored characteristic.

For example, the biometric sensor may be a fingerprint sensor, and the data storage device may include a verification processor arranged to compare a fingerprint received by the fingerprint sensor with a stored fingerprint. Alternatively or additionally, the biometric sensing may employ the audio sensor, i.e. recognising the voice of a predetermined user.

Preferably, the data storage device only transmits data stored within it when the verification processor determines that there is a match between the recorded biometric characteristic and the stored characteristic.

Note that it is not indispensable to the invention that the verification processor and control processor are physically different units. The verification processor and the control processor may, if desired, be different functions of a single integrated circuit (master control unit). Alternatively, any other number of integrated circuits may be used to implement together the function of the control processor and verification processor.

The device may include the capability to compress/decompress data which is to be stored, or has been stored, in the non-volatile memory. This can be implemented by the processor which stores data into and retrieves data from the non-volatile memory, or alternatively by a dedicated microprocessor unit.

The device may be integrated with an image capturing device (camera) for generating data which can be stored in the non-volatile memory, and subsequently transmitted through the wireless transceiver.

The device may incorporate at least one smart card, for providing at least one enhanced security feature. For example, the smart card may be capable of encryption of data for storage in the memory, and/or capable of encryption of data to be transmitted using the wireless transceiver and/or decryption of data received via the wireless transceiver.

The data storage device may be used as part of a multi-unit system having a second electronic device (such as a PDA, desktop computer or laptop computer) having a wireless transceiver for communicating with the data storage device. The system may further comprise one or more further electronic devices which include respective wireless transceivers for exchanging data with the data storage device. Thus, the data storage device may be arranged as a “bridge”, which can be used to store data received from a first of the electronic devices and subsequently to transmit that data to a second of the electronic devices (optionally with some processing of the data within the data storage device, such as an encoding operation).

The further electronic devices may be “slave devices” of the second electronic device, such as the PDA.

Each of the wireless transceivers preferably operates by electromagnetic waves, and most preferably by RF or infra-red waves. In the former case, the transceiver may consist of an antenna and RF interface circuitry. Irrespective of the wireless waves employed, the transceiver may use any protocol presently in existence or which may become available in the future, for example it may be capable of sending and/or receiving signals in at least one of the following communication protocols: (i) IEEE802.11, (ii) Bluetooth, (iii) irDA, or (iv) UWB.

It is also possible that the data storage device may be capable of receiving/transmitting in multiple formats, so that it can interpret between two said electronic devices which use different formats. That is, the data storage device may be arranged to receive data from one electronic device in one communication protocol and re-transmit it to a different one of the electronic devices in a different communication protocol.

Preferably, any of the electronic devices which includes an internal memory is arranged, upon that internal memory becoming full, or at least the amount of data passing a predefined limit, to initiate communication with the data storage device, so that the data can be transferred to the data storage device.

Preferably all communications carried out by the data storage device include a process of establishing the identity of the other electronic device using an ID code received from that electronic device and compared with list of ID codes stored internally by the data storage device.

A second expression of the invention is a method of inputting data using a data storage device of the kind discussed above to an electronic device, the method including
(i) using the position sensing device(s) comprised by the data storage device to generate position data;
(ii) using wireless transceiver comprised by the data storage device to transmit the data wirelessly to a transceiver of the electronic device.

### BRIEF DESCRIPTION OF THE FIGURES

Preferred features of the invention will now be described, for the sake of illustration only, with reference to the following figures in which:

FIG. 1 is a schematic view of a computer system including data storage device which is a first embodiment of the invention;

FIG. 2, which is composed of FIGS. 2(a) and 2(b), is two schematic views of the data storage device of FIG. 1;

FIG. 3 shows the steps performed by the data storage device in a first method employing the system of FIG. 1;

FIG. 4 shows the steps performed by the data storage device in a second method employing the system of FIG. 1;

FIG. 5 shows the steps performed by the data storage device in a third method employing the system of FIG. 1;

FIG. 6 shows the processes of FIG. 4 or 5 from the point of view of a user;

FIG. 7 shows schematically a cross-sectional side view of a data storage device which is a second embodiment of the invention;

FIG. 8 shows the internal construction of the embodiment of FIG. 7;

FIG. 9 shows schematically a cross-sectional side view of a data storage device which is a third embodiment of the invention;

FIG. 10 shows the internal construction of the embodiment of FIG. 9; and

FIG. 11 shows the steps performed by the data storage device in a method employing the system of FIG. 1.

### DETAILED DESCRIPTION OF THE EMBODIMENTS

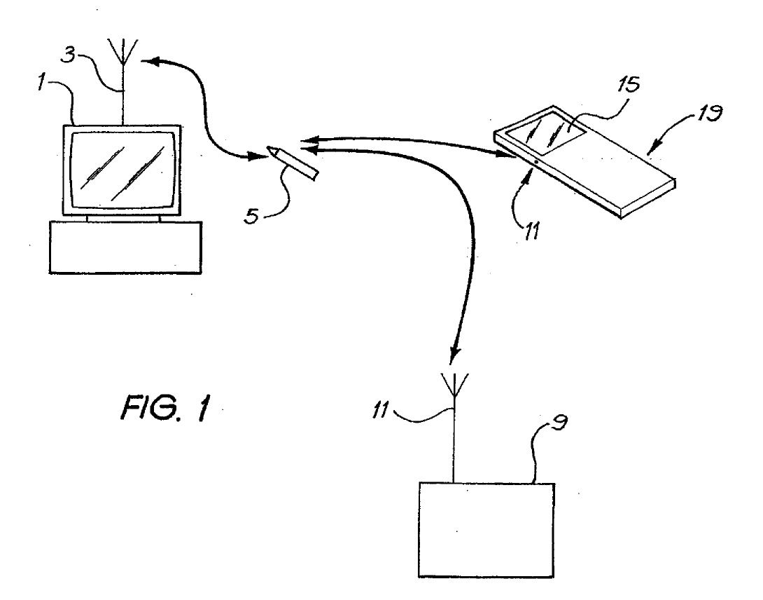

Referring to FIG. 1, a system embodying the invention includes a first electronic device 1, which may be a PC, having an antenna 3. The system also includes a data storage device 5, having an antenna 37 (not shown in FIG. 1). The system typically further includes a plurality of further electronic devices 9, 19 which are external to the computer device 1 and spatially separated from it. The further electronic devices may be independent of the PC 1 (e.g. one of the devices 9, 19 may be a PDA, a digital still camera (DSC), a video camera, an e-book, or a smart phone) or be slave devices of the PC. The further electronic devices may each have a screen, such as a touch-sensitive screen. The further electronic devices 9, 19 are devices which may usefully communicate data to and/or from the PC 1 and/or each other. Each further electronic device 9, 19 has an antenna 11. For simplicity only further electronic devices 9, 19 are illustrated in FIG. 1. The data storage device 5 and each of the further electronic devices 9, 19 are portable. For example, their weight is preferably less than 1 kilogram each, and each preferably includes an internal power source such as a battery.

The PC 1 and the data storage device 5 can communicate using the antenna 3 and the antenna of the data storage device 5. Similarly, the data storage device 5 and the further electronic devices 9, 19 can communicate using the antenna of the data storage device 5 and the antennas 11. Both forms of communication may be using any of the communication protocols IEEE802.11, UWB, Bluetooth, irDA, etc. As described below, any of the further electronic devices 9, 19 can send data selectively to the PC 1 or to any of the other further electronic devices 9, 19 via the data storage device 5. The PC 1 can send data to a selected one of the further electronic devices 9, 19 via the data storage device 5. All of this communication is digital, and the data storage device 5 is for digital data. In addition, it is possible that the data may be sent in an encrypted form. Any one of the PC 1 or the further electronic devices 9, 19 can function as the “host” in the following description.

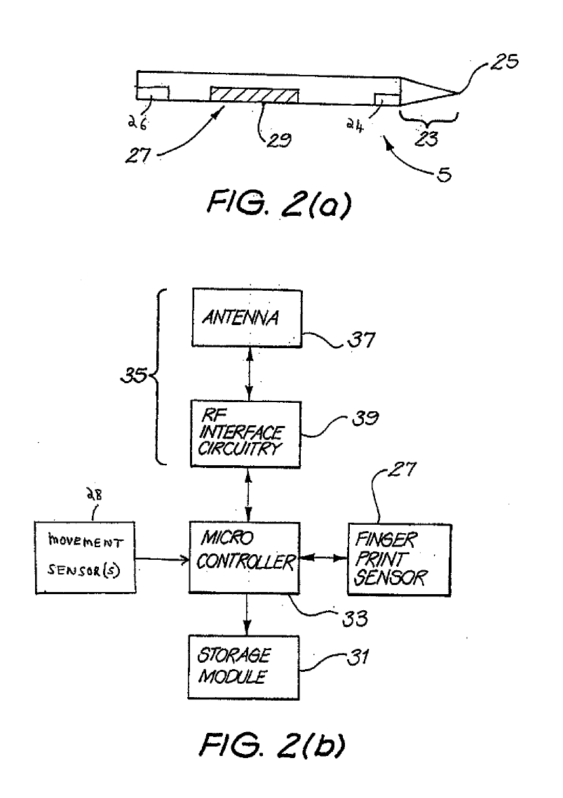

Turning now to FIG. 2, the construction of the data storage device 5 is shown, respectively as a cross-sectional side view (FIG. 2(a)) and as a block diagram (FIG. 2(b)).

The device 5 includes an outer housing including a tapering stylus portion 23 having a tip 25, so that the whole device 5 may be considered as a stylus. The stylus portion 23 is shown as conical, but may be any tapering shape. The antenna 37 of the device 5 is not shown in FIG. 2(a), but is preferably provided at or proximate the end of the device 5 which is opposite from the stylus portion 23 (i.e. at the other end of the housing). The exterior surface of the housing includes a fingerprint sensor 27 having a surface 29 which is substantially flush with the housing. When a user applies his finger to the surface 29, the fingerprint is recorded. The device normally further includes a battery, or other power transmission device.

The interior of the data storage device 5 includes a data storage module 31, a microcontroller (master control unit) 33 in two-way communication with the data storage module 31 and with the fingerprint sensor 27. The microcontroller 5 is further in communication with a transceiver 35 comprising the antenna 37 and RF interface circuitry 39. The transceiver 35 is arranged for receiving an RF signal by the antenna 37, and to extract digital data from it in the RF interface circuitry 39, which passes the data to the microcontroller 33, which stores it in the storage module 31. When the data storage device 5 is to transmit data, the microcontroller 33 issues a signal to the storage module 31 which transmits data stored within it to the microcontroller 33, which then passes the data to the transceiver 35 for transmission.

The data storage device 5 includes one or more (two are shown) position sensing devices 24, 26. They are indicated collectively as box 28 in FIG. 2(b). Each of the position sensing devices 24, 26 may, for example, be an accelerometer, such as the three axis low-g micro-machined accelerometer MMA7260Q sold by Freescale Semiconductor. Alternatively, one of more of the position sensing devices may be a gyroscope device.

Note that the full three-dimensional position of the data storage device 5 can be obtained from the outputs of three spaced apart accelerometers (i.e. in all three translational degrees of freedom, and in all three rotational degrees of freedom). However, in some embodiments of the invention not all this information is generated. For example, it may be sufficient to provide a single accelerometer 24 proximate the tip stylus (perhaps even within the conical tip), for generating only information about three, or even only two, translational degrees of freedom. Such information would be at least as informative as that generated by a conventional mouse which is moved over a two-dimensional surface.

The host may be provided with software which is able to interpret the position data transmitted to the host by the transceiver 35, and derive commands from the position data. For example, the host may generate a cursor which (like a conventional cursor) moves in two dimensions on the surface of a screen of the host, responsive to motions of the tip of the stylus. For example, the position data may be indicative only translational motions of the tip of the stylus in the two orthogonal directions normal to the axis of the stylus, and the two-dimensional motions of the cursor on the screen may be proportional to the motions of the tip of the stylus in the two respective directions.

The data storage device 5 may optionally include one of more data input mechanisms, such as one or more buttons (not shown on FIG. 2(a)) for inputting commands. Data encoding the commands may be transmitted out of the device to the host using the antenna 37 of the data storage device 5.

In this case the motion of the cursor on the screen, and the commands entered using the data input mechanism(s), can be used together to enter data into the computer in a manner closely analogous to the operation of a conventional PC mouse. Note that there is no requirement for the stylus to directly contact the screen of the host, and that the screen may accordingly be non-touch-sensitive.

Optionally, the operations of the data storage device 5 (and in particular the operation of transmitting data via the transceiver 35) are only enabled in the case that fingerprint sensor 27 has recorded a fingerprint, transmitted it as fingerprint data to the microcontroller 33, and the microcontroller has compared that fingerprint data to data pre-stored in the storage module 31 (or in some other memory, which is not shown).

The memory capacity of storage module 31 of the data storage device 5 may for example be at least 8 MB, at least 1 GB, at least 10 GB, or at least 20 GB. The storage module 31 of the storage device 5 can be, for example, a magnetic disk drive, an optical disk drive, or any other suitable non-volatile data storage device, such as an electrically erasable programmable read only memory (EEPROM), a ferroelectric random access memory (FRAM), a magetoresistive random access memory (MRAM), or any other data storage device which may become available in the future.

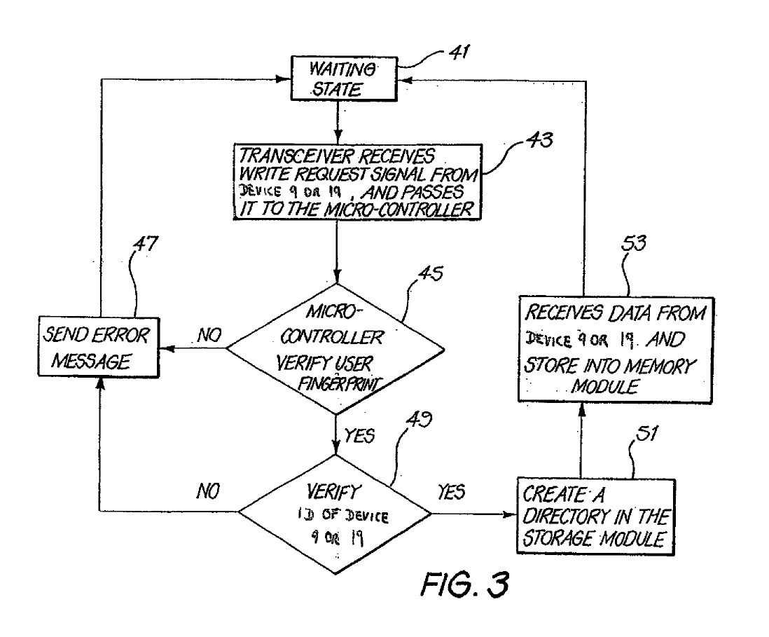

Turning to FIG. 3, a method using the system of FIG. 1 is shown. In this method, the data storage device 5 receives and stores data from one of the electronic devices 9, 19. Initially, the data storage device 5 is in a waiting state 41. In step 43, the transceiver 35 receives data via the antenna 37 from one of the devices 9, 19, and passes it to the microcontroller 33.

In step 45, the microcontroller 33 uses the fingerprint sensor 27 to verify the finger print of a user holding it. If the measured fingerprint does not match the fingerprint data stored in the storage module 31, an error message is generated in step 47, and the device returns to the waiting state 41.

Otherwise, in step 49, the data storage device 5 verifies an ID (password) of the further electronic device 9 or 10 from the data it received (e.g. comparing the ID encoded in the data with an ID stored in a list in the storage module 31). If this verification process fails, the data storage device 5 moves to step 47. Otherwise, the data storage device 5 passes to step 51 in which the microcontroller 33 creates a directory in the storage module 31, and step 53 in which the data storage device 5 continues to receive data from the electronic device 9, 19 and stores it in the storage module 31.

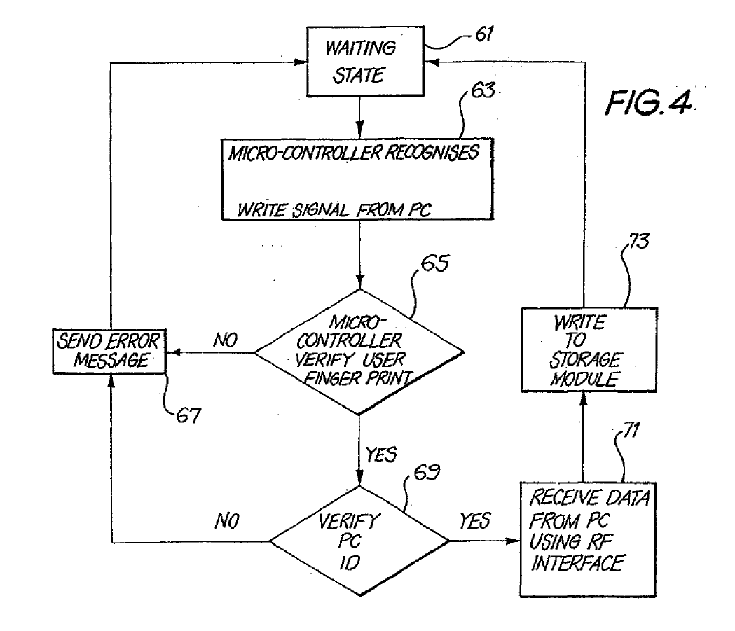

Turning to FIG. 4, a second method using the system of FIG. 1 is shown. In this method, the data storage device 5 receives and stores data from the PC 1. Initially, the data storage device 5 is in a waiting state 61. In step 63, the transceiver 35 receives data via the antenna 37 from the PC 1. The data is a write signal indicating that data is to be written from the PC 1 to the memory device 5.

In step 65, the microcontroller 33 uses the fingerprint sensor 27 to verify the finger print of a user holding it. If the measured fingerprint does not match the fingerprint data stored in the storage module 31, an error message is generated in step 67, and the device returns to the waiting state 61.

Otherwise, in step 69, the device verifies an ID of the PC 1 within the data it received (e.g. comparing a ID encoded in the data with an ID stored in the list in the storage module 31). If this verification process fails, the device moves to step 67. Otherwise, the device passes to step 71 in which the microcontroller 33 receives data from the PC 1 using the transceiver 35, and step 73 in which the microcontroller 33 stores the data in the storage module 31.

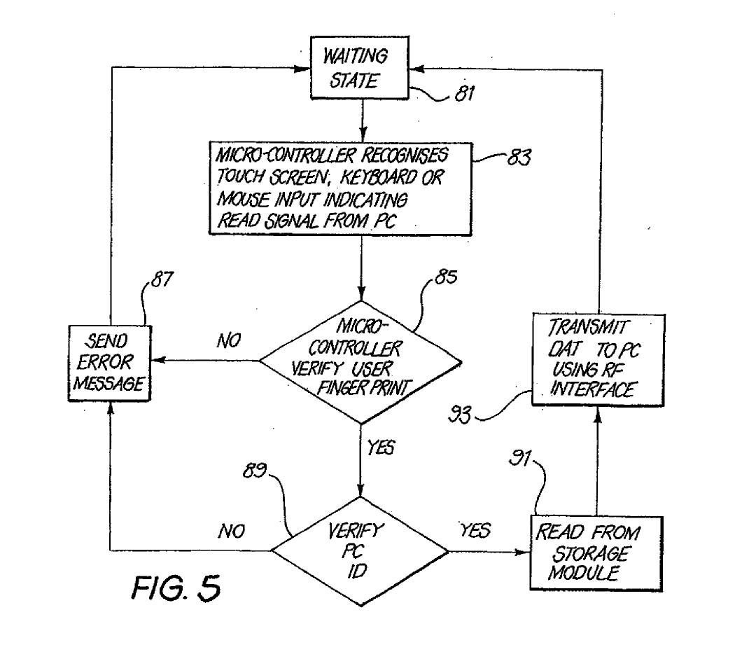

Turning to FIG. 5, a third method using the system of FIG. 1 is shown. In this method, the data storage device 5 transmits data to the PC 1. Initially, the data storage device 5 is in a waiting state 81. In step 83, the transceiver 35 receives data via the antenna 37 from the PC 1. The data is a read signal indicating that data is to be written to the PC 1 from the memory device 5.

In step 85, the microcontroller 33 uses the fingerprint sensor 27 to verify the finger print of a user holding it. If the measured fingerprint does not match the fingerprint data stored in the storage module 31, an error message is generated in step 87, and the device returns to the waiting state 81.

Otherwise, in step 89, the device verifies an ID of the PC 1 within the data it received (e.g. comparing a ID encoded in the data with an ID stored in the list in the storage module 31). If this verification process fails, the device moves to step 87. Otherwise, the device passes to step 91 in which the microcontroller 33 receives data from storage module 31, and in step 93 sends it to the PC 1 using the transceiver 35.

A process very similar to that shown in FIG. 5 occurs in the case that data is to be transmitted to one of the further electronic devices 9, 19. It differs in that step 83 is replaced by a step in which the storage device 5 receives a read request from the further electronic device and passes it to the microcontroller 33, step 89 is replaced by a step in which the identity of the further electronic device is confirmed using an ID of the further electronic device, and step 93 is replaced by a step in which the data is transmitted by the transceiver 35 to the further electronic device.

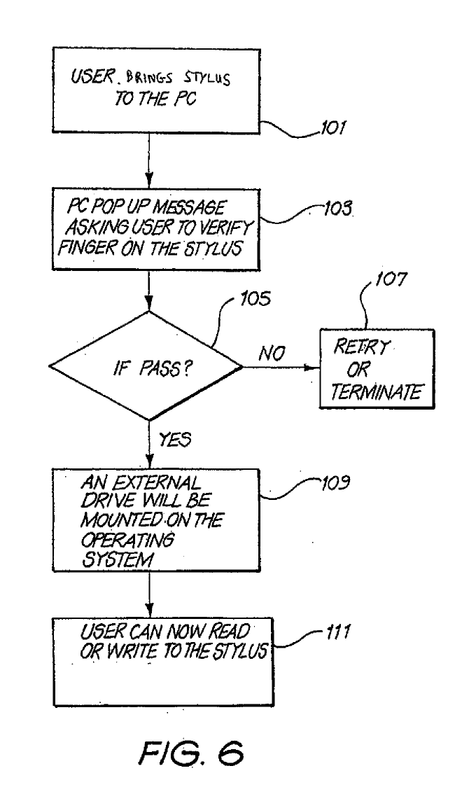

FIGS. 4 and 5 showed the process of transferring data between the data storage device 5 and the PC 1 from the point of view of the device 5. However, referring to FIG. 6, these processes are shown from the point of view of a user.

In step 101, a user brings the stylus 5 close to the PC, within the range of their respective transceivers 3, 35. In one form, the data storage device 5 and/or PC 1 may recognise that they are within communication distance and start communicating spontaneously. Alternatively, the user may initiate the process of mutual recognition.

In step 103, a pop-up message appears on the screen of the PC 1 asking the user to verify his identity by placing his finger on the sensor 27 of the stylus 5.

In step 105, a determination is made by the microcontroller 33 of whether there is a match. If not, in step 107 the user is invited to retry, or terminate the attempt.

Otherwise in step 109, the operating system of the PC (or other host system) is configured to recognise an external drive (corresponding to the storage module 31), and in step 110 the user can read or write to/from the storage module 31 of the stylus 5 by inputting commands. As discussed above, the data input can be by moving the data storage device 5 and/or by using the data input mechanism(s) mounted on the data storage device. Alternatively, the command may be given by any conventional mechanism, such as by a touch-sensitive screen of the host, a keyboard or a mouse.

In certain forms of the embodiment, the user can tap the stylus 5 onto a screen of the PC 1 at a location corresponding to one at which a symbol indicating a file is displayed (for example, the symbol may be an icon indicating the file and displayed as part of a file-access system such as Windows Explorer running on the PC). This, simultaneously indicates a file which is to be copied onto the data storage device, and initiates the storage procedure (“tap and store”).

In addition to these functions, the user is additionally able to enter data into, or read data from, any other electronic device, such as the devices 9, 19, which is able to communicate with the transceiver 35 of the data storage device 5. This process follows a flow diagram essentially equivalent to that of FIG. 6, optionally initiated by a tap from the stylus 5 onto the device 9, 19.

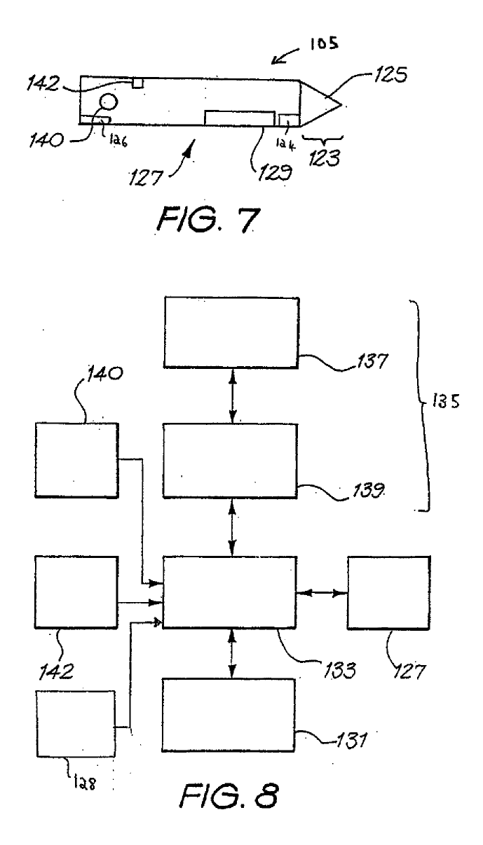

FIG. 7 shows a second embodiment of a data storage device 105 according to the invention. Items of FIG. 7 corresponding to those of FIG. 2(a) are given reference numerals 100 higher. The data storage device 105 incorporates a digital camera device 140 within the same housing. The digital camera device 140 is capable of taking images (still images, and/or in certain versions of the embodiment moving images). The device may also include a sound receiving device (microphone) 142 capable of recording audio sound.

The functional structure of the second embodiment is as shown in FIG. 8. Elements corresponding to those of FIG. 2(b) are given reference numerals 100 higher. Data representing the images and/or sound captured by the camera 140 and microphone 142 are stored by the micro-controller 133 in the memory 131. As in the first embodiment, RF interface circuitry is provided, for receiving data from and transmitting data to an antenna 137 which is part of a transceiver 135 further including RF interface circuitry 139.

Note that the device preferably has all the functionality of the first embodiment. That is, it is able to receive data via the aerial 137, store it in the memory unit 131, and then re-transmit it, so that in this way the data storage device can transfer data among a plurality of devices.

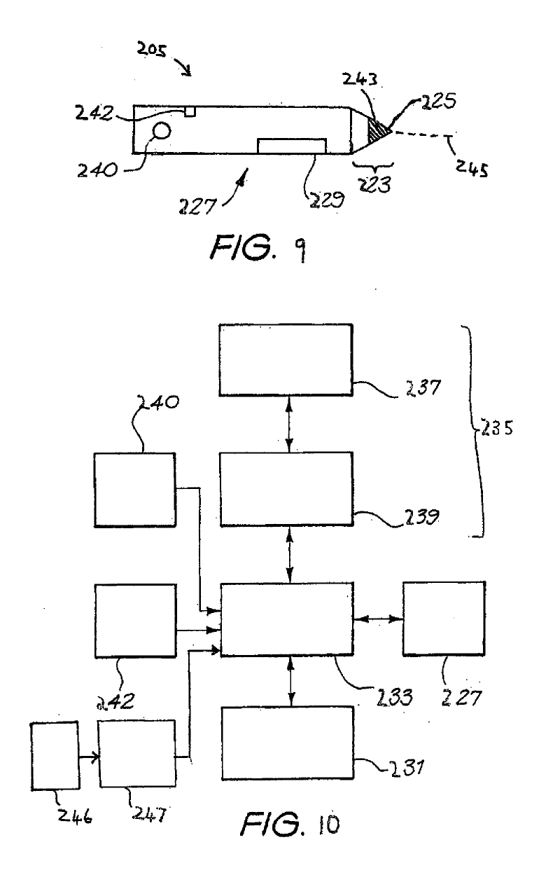

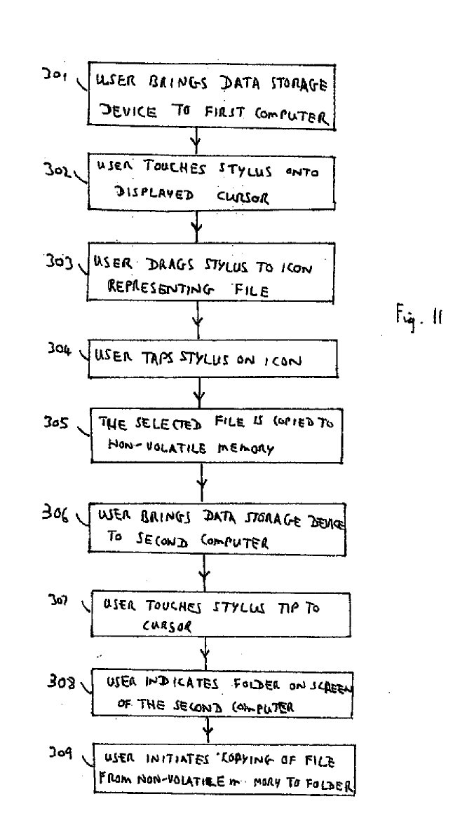

A third embodiment of the invention is illustrated in FIGS. 9 and 10. Elements of this third embodiment which correspond to those of the first second embodiment are given reference numerals 200 higher. The third embodiment is a data storage device 205 which includes, instead of the position sensing devices 24, 26, 124, 126 of the first and second embodiments, a laser-reader head 243 mounted near the tip 225. The laser-reader head 243 comprises a laser generation unit which generates and transmits a laser beam out of the device. The laser beam is indicated by the dashed line 245. The laser-reader head 243 further includes a light sensor unit 246 which receives reflected light from the laser beam 245, and a signal generation unit 247 which generates a signal based on the reflected light. The laser generation unit may be arranged to transmit the laser beam 245 in a plurality of directions within a certain angular range, e.g. sequentially in a raster fashion. Thus, the reflected light collected by the light sensor unit 246 indicates the characteristics of a surface which the laser beam impacts. By comparing the reflected light at two different times, any change in the position of the data storage device 205 can be detected.

The output of the signal generation unit 247 is transmitted to the micro-controller 233, where an algorithm is performed to determine which movements the device has made. This can be performed using algorithms which are known to a skilled reader from the field of hand-held mice which slide across a surface. In other forms of the embodiment, the output of the signal generation unit 247 is transmitted to the host through the transceiver 235 (comprising the antenna 237 and RF interface circuitry 239) without modification by the micro-controller 233, such that the host determines the movements of the data storage device 205. In either case, the movements may then be used to select one of a number of options defined by software run respectively in the micro-controller 233 or the host.

For example, if the software causes a screen of the host to display four options in respective locations on the screen, a movement of the data storage device 205 towards one of those four locations is detected and taken as a selection of one of the options.

Like the second embodiment, the third embodiment comprises a camera 240 and an audio sensor 242. The micro-controller may be arranged either to transmit the output of the audio sensor 242 to the host, or to process the output itself. In either case, an algorithm is preferably performed on the output of the audio sensor 242 to detect voice commands, which the micro-controller 233 or host implements. For example, the user may be able to indicate that contact between the micro-controller and the host is to be terminated.

Optionally, the output of the audio-sensor 242 may be used in addition to, or instead of, the output of the fingerprint sensor 227, for the biometric identification of the user. In this case, the biometric sensor 229 may be omitted.

A further possible enhancement of the first, second and third embodiments of the invention is that they may be provided with the capability to compress data which is to be stored in the memory units 31, 131, 231. This is related to the concept discussed in PCT patent application “System and Apparatus for Compressing and Decompressing Data Stored to a Portable Data Storage Device”, PCT/SG02/00086, filed 13 May 2002, the entire disclosure of which is incorporated herein by reference. The compression algorithm may for example be stored in a ROM memory and uploaded into the processors 33, 133, 233 and performed there. Alternatively, the device may contain a separate compression engine (not shown).

Optionally, in addition to data compression, the portable storage device is arranged to decompress the data before transmitting out of the device. Again this may be performed by the processors 33, 133, 233, or by a decompression engine, which may in fact by the same microprocessor as the compression engine.

Another possible enhancement of the first, second and third embodiments of the invention is that the device may include some form of “smart card”, to provide one or more additional security functions, e.g. to perform encryption of data (e.g. before storage and/or before transmission out of the device), or to detect some improper usage of the device and, upon this detection, to alter the functioning of the device, for example to inhibit the transmission of data from the memory modules 31, 131, 231 (or indeed to delete all data stored there).

FIG. 11 shows a particularly interesting way of employing the invention, using the “tap and store” procedure mentioned above. In a step 301, a user brings the data storage device (which may be any one of the first, second or third embodiments described above) to a first electronic device (such as the PC 1, or any of the other electronic devices) having a screen. In a step 302, the user touches the stylus tip to a cursor displayed on the screen of the first electronic device. In a step 303, the user drags the stylus to an icon displayed on the on the screen of the first electronic device and indicating the existence of a file (the on-screen cursor follows the tip of stylus to the desired file). In a step 304, the user “taps” the tip of the stylus on the icon representing the desired file. In step 305, the transfer of the desired file from the first electronic device to the non-volatile memory of the data storage device commences. In step 306, the user brings the data storage device to a second electronic device. In step 307, the user touches the stylus tip to a cursor displayed on the screen of the second electronic device. In setp 308, the user drags the stylus to an icon representing a desired destination folder on the screen of the second electronic device (the on-screen cursor follows tip of stylus to the destination folder). In step 309, the user initiates some control function (e.g. pushing a button on stylus) to initiate transfer of the file to destination folder of the second electronic device. Note that in this process there is a close relationship between the mouse-like function of the stylus (i.e. the ability of the stylus to indicate a location on a screen) and the data storage functionality of the device.

Many forms of smart card are known, including for example cards which can sense that the housing of the device has been opened, and cards which contain identity information. Optionally, for example, the fingerprint sensing described above can be implemented using the smart card.

Note that, although the invention has been described above with reference to only two embodiments, many further variations are possible within the scope of the invention as will be clear to a skilled reader. For example, it is possible for the data storage device 5 to include a physical interface allowing it to be connected to another electronic device or apparatus allowing data to be transmitted into or out of the data storage device respectively from or to the other electronic device via the physical interface. For example, the physical interface may be a plug, such as a USB plug or a Firewire plug, which can be directly connected to a socket in the other electronic device.

1. A data storage device having:
a non-volatile memory;
a wireless transceiver for transmitting and receiving data;
a control processor for storing data received by the wireless transceiver in the memory, and for extracting data from the memory and transmitting it to the wireless transceiver for transmission;
a housing having an outer profile including a stylus portion defining a tip; and
one or more position sensing devices in fixed positional relationship to the housing; and
wherein manipulating the data storage device to be proximate to a first electronic device causes the one or more position sensing devices to generate position data which comprises (a) data indicating a position on a screen of the first electronic device, a representation of a file being displayed at the position on the screen, and (b) data providing a command for the first electronic device to transmit the file to the data storage device, the data storage device storing the file in the non-volatile memory.

2. A data storage device according to claim 1 further comprising at least one biometric sensor for recording a biometric characteristic of a user, and a verification processor for comparing the biometric characteristic with a characteristic stored by the sensor, the verification processor controlling whether the data storage device performs at least one of its functions in dependence upon whether the recorded biometric characteristic matches the stored characteristic.

3. A data storage device according to claim 2 in which the biometric sensor is a fingerprint sensor, and the data storage device includes a verification processor arranged to compare a fingerprint received by the fingerprint sensor with a stored fingerprint.

4. A data storage device according to claim 2 which is arranged only to transmit data stored within it when the verification processor determines that there is a match between the recorded biometric characteristic and the stored characteristic.

5. A data storage device according to claim 1 which is integrated with a camera device, the camera device being arranged to generate data representing images and to store the image data in the non-volatile memory.

6. A data storage device according to claim 1 in which the control processor is arranged to perform a compression algorithm to compress data which is to be stored in the non-volatile memory.

7. A data storage device according to claim 1 further including a smart card for performing at least one security function in relation to data stored in the non-volatile memory.

8. A data storage device according to claim 1 in which the data storage capacity of the non-volatile memory is at least 8 MB.

9. A data storage device according to claim 1 in which the position sensing devices generate position data indicative of the translational movements of the tip of the housing.

10. A data storage device according to claim 1 in which the position sensing device comprises a laser-reading head for generating a laser beam, receiving a reflection of the laser beam, and generating a signal indicative of the reflection.

11. A data storage device according to claim 1 further comprising an audio-sensor.

12. A data storage device according to claim 11 comprising a micro-controller which is operative to detect a voice command in the output of the audio-sensor, and to perform the command.

13. A method of inputting data using a data storage device according to claim 1 into another electronic device, the method including:
(i) using the one or more position sensing devices comprised by the data storage device to generate position data; and
(ii) using wireless transceiver comprised by the data storage device to transmit the data wirelessly to a transceiver of the electronic device.

14. A method of transferring data between a first and second electronic device using a data storage device, the method including:
(i) manipulating the data storage device proximate the first electronic device to cause the one or more position sensing devices to generate position data which comprises (a) data indicating a position on a screen of the first electronic device, a representation of a file being displayed at said position on the screen, and (b) data indicating a command for the first electronic device to transmit the file to the data storage device, the data storage device storing the file in the non-volatile memory;
(ii) moving the data storage device to be proximate to the second electronic device; and
(ii) causing the data storage device to transmit the data to the second electronic device.
